(19) United States
(12) Patent Application Publication
(10) Pub. No.: US 2008/0148319 A1
(43) Pub. Date: Jun. 19, 2008

(54) Coordinating web media with time-shifted broadcast

(75) Inventors: Michael Dennis Facemire, Pittsboro, NC (US); Michael C. Wanderski, Durham, NC (US); Douglas John Geiger, Apex, NC (US)

Correspondence Address: STEVEN E. BACH, ATTORNEY AT LAW, 10 ROBERTS ROAD, NEWTOWN SQUARE, PA, 19073, US

(73) Assignee: International Business Machines Corporation

(21) Appl. No.: 11/639,500

(22) Filed: Dec. 14, 2006

(51) Int. Cl. G06F 3/00

(52) U.S. Cl. 725/58

(57) ABSTRACT

A method and a program product are provided for coordinating web media with a time-shifted broadcast. Time perspective information for a time-shifted broadcast is acquired. Then, web content corresponding to the time perspective for the time-shifted broadcast is provided.

### BACKGROUND

In the business environment and in the personal environment, there is an increasing use of digital video recorders DVR's to record programming and watch the recorded programming at a time other than the time that it was originally broadcast (i.e., time-shifted broadcast). Moreover, it is quite common for people to not only watch previously recorded programming, but to prefer to use the additional time-shifting techniques of pausing and resuming the programming for personal convenience. This allows the viewer to pause programming when he/she wants to take a break, answer a telephone call, etc. without missing any of the programming.

While time-shifting technology is becoming more pervasive, web-based collaboration technology is also becoming more popular, allowing people watching common programming to discuss it online or to access information that enhances the experience of viewing the programming. Unfortunately for viewers, as these two technologies become more advanced, their applications diverge further apart. In effect, a viewer of a time-shifted broadcast must choose between forgoing collaboration technology available for the broadcast that is being time-shifted or risking disclosure of events later in the broadcast through the use of collaboration technology.

### SUMMARY

The invention provides a method and program product for coordinating web media with a time-shifted broadcast. In an exemplary embodiment of the invention, a user viewing a time-shifted broadcast makes a request for time coordinated web content. A web site acquires time perspective information for the time-shifted broadcast. The time perspective information may be acquired either directly from a DVR presenting a time-shifted broadcast (through a periodic broadcast of time perspective information by the DVR) or from a networked device making the request for web content. The web site provides time-coordinated web content (i.e., a web page corresponding to the time perspective for the time-shifted broadcast) to the networked device. The networked device then provides the time coordinated web content to a display for viewing.

The invention further provides program products for acquiring, using and providing time perspective information and for identifying and providing time coordinated web content. The program products are provided for use at a web site, at a networked device, or at a combination thereof

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of system for coordinating web media with a time-shifted broadcast according to an exemplary embodiment of the invention;

FIG. 2 shows a broadcast interface and a web client interface for displaying a time-shifted broadcast and time coordinated web content according to an exemplary embodiment of the invention;

FIG. 3 is a flow diagram for a method for coordinating web content with a time-shifted broadcast according to an exemplary embodiment of the invention;

FIG. 4 is a block diagram of an alternative system for coordinating web media with a time-shifted broadcast according to an alternate exemplary embodiment of the invention;

FIG. 5 is a multimedia display presenting a time-shifted broadcast and time coordinated web content according to an alternate exemplary embodiment of the invention;

FIG. 6 is a flow diagram at a web site for another method for coordinating web content with a time-shifted broadcast according to an exemplary embodiment of the invention;

FIG. 7 is a flow diagram at a networked client device for the method of FIG. 6 for coordinating web content with a time-shifted broadcast according to an exemplary embodiment of the invention.

### DETAILED DESCRIPTION

The invention provides a method and a program product for coordinating web content with a time-shifted broadcast. Time perspective information for the time-shifted broadcast is acquired, and web content coordinated with the time perspective of the time-shifted broadcast is provided to the viewer of the time-shifted broadcast.

To facilitate this technology, a DVR is enabled to make available a timestamp during a time-shifted broadcast. Assuming the DVR is network enabled, the DVR may make the timestamp available directly to a web application server. This may be done through the DVR transmitting a periodic broadcast mechanism (such as UDP broadcast) or by the DVR responding to a request of time (such as an IP/HTTP request).

Alternatively, a networked device such as a computer may acquire the timestamp and provide it to the web application server. A protocol such as UPnP may be used to establish communication between the DVR and the computer or other networked device. A browser on the networked device makes a request for web content. The browser may append program identification (such as a TV show) and a timestamp (user's perspective of time) to the User-Agent header of a web page request. This may be done for example using a plugin. Since the HTTP header supports arbitrary extension as part of the standard, websites are free to respond to or ignore the additional information in the header.

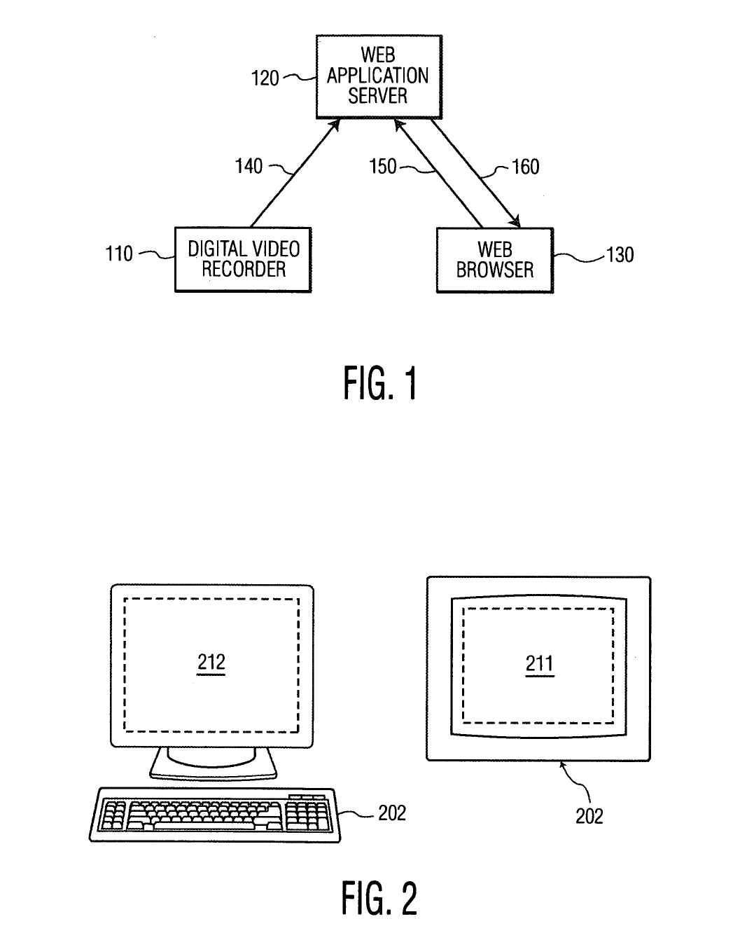

Web sites supporting time-shifting behavior may acquire the timestamp from the DVR or the networked device and use the timestamp together with their auditing trail information (versioning, etc) to influence how the web page is rendered. Thus, the web site may render time-coordinated web content. That is, a web page may be provided having content coordinated with the time perspective of the time-shifted broadcast. FIG. 1 is a block diagram of system for coordinating web content with a time-shifted broadcast according to an exemplary embodiment of the invention. In this system, a DVR 110 transmits time reference information 140. In an exemplary embodiment, the time reference information comprises a timestamp of a time-shifted broadcast running on the DVR 110 and user or client identification for the DVR 110. The DVR may be a self-contained device or an account in a distributed digital network, or any other configuration having the ability to capture and time-shift a broadcast. The timestamp may, for example, be a representation of the time perspective of the broadcast. That is, the time at which a particular moment of the time-shifted broadcast was originally broadcast before time-shifting.

A web page request 150 is sent from a web browser 130 to a web application server 120. The web browser resides on a client networked device, such as a personal computer. The web page request 150 may be in any format recognizable by the web application server 120. In the exemplary embodiment, the web page request is for a web page having on-line collaboration content directed to a program that is being viewed in a time-shifted manner by a user making the request. The web page request also identifies the networked client device on which the request was made.

In this embodiment, the web application server 120 acquires the time perspective information 140 from the DVR 110 for the time-shifted broadcast being run on the DVR 110. The web application server 120 also receives the web page request 150 from a web browser 130 on a client networked device. In response to the web page request 150, the web application server 120 using its audit trail or versioning information identifies and provides time coordinated web content 160 that is time-shifted to correspond to the time perspective for the time-shifted broadcast. The time coordinated web content 160 may be, for example, an archived web page created prior to the latest timestamp received in the time reference information 140 from the DVR 110. Alternatively, the time coordinated web content 160 may be a current web page with content entered after the latest timestamp received in the time reference information 140 from the DVR 110 either hidden or deleted.

FIG. 2 shows a broadcast interface 201 and a web client interface 202 for displaying a time-shifted broadcast 211 and time coordinated web content 160 according to an exemplary embodiment of the invention. The broadcast interface 201 is presenting a time-shifted broadcast 211, which is for example, a program that was originally broadcast at an earlier time and is time-shifted by the use of a DVR. In the illustrated embodiment, a viewer of the time-shifted broadcast 211 is also using on-line collaboration technology to view collaborative time coordinated web content 160 that is modified to coordinate with the time-shifted broadcast 211 on the web client interface 202. The web client interface 202 is, for example, a monitor for a client networked device such as a personal computer. The collaborative time coordinated web content 160 may be interactive communication with other viewers about the program bring presented by the time-shifted broadcast 211 or contextual information for enhancing the program, or the like. The time coordinated web content 160 is modified such that it does not include content entered after the most recent timestamp from the time-shifted broadcast.

If the collaborative web content were provided in real-time, then it would not be coordinated with the time-shifted broadcast 211, thereby creating the risk of providing information that anticipates events not yet viewed in the time-shifted broadcast 211 and detracts from suspense and excitement generated by those events in their natural sequence. For example, in the case of a dramatic program, real time web content that includes interactive dialog about a surprising twist in the drama would detract from the intended effect for a viewer of a time-shifted broadcast of that program. Similarly, real time web content that included statistics for a sporting event, such as a shot tracker or on-line game analysis, would detract from the suspense for a viewer of a time-shifted broadcast 211 of that sporting event by disclosing the results of action that has not yet been viewed.

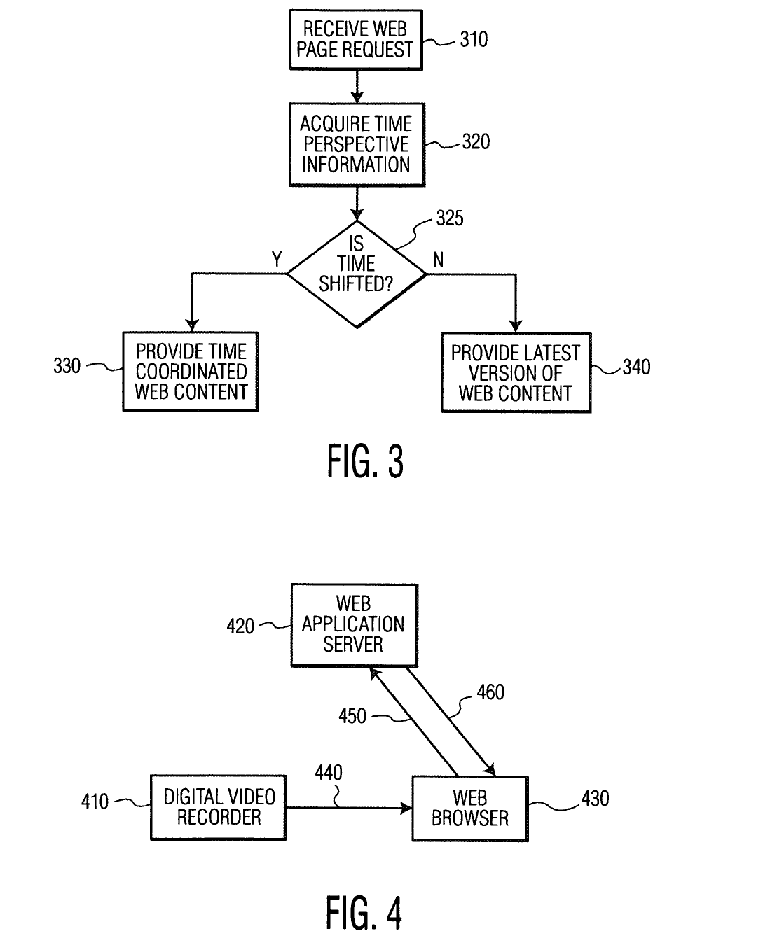

FIG. 3 is a flow diagram for a method for coordinating web content with a time-shifted broadcast according to an exemplary embodiment of the invention. The web application server 120 acquires the time perspective information 140 from the DVR 110 for the time-shifted broadcast 211 (step 320). The web application server 120 also receives a web page request 150 from a web browser 130 on a networked client device 202 (step 310). In response to the web page request 150, the web application server 120 determines whether or not the web page request 150 is for a program that is time-shifted (step 325). This determination step may be accomplished, for example, by matching the client identification from the web page request 310 and the client identification from the time perspective information 140. If the web page request is not associated with a time-shifted broadcast, then the web application server provides the latest or real time version of the requested web page (step 340). If the web page request is associated with a time-shifted broadcast, then the web application server provides time coordinated web content 160 (step 330).The time coordinated web content 160 is time-shifted to correspond to the time perspective for the time-shifted broadcast 211.

By way of illustration of the foregoing embodiment, following is a description of the embodiment in which a user is viewing a basketball game. As is currently very common, the user watching the basketball game is also following the progress of the game on the web. In this example, a shot tracker on a web sports site is used to watch where shots have been taken by certain players, and a detailed real time play-by-play analysis is used to better understand the nuances of the game. While this model makes sense when the broadcast of the game and the web content are both consumed in real time, time-shifting of the game broadcast would throw the web content out of sync with the game broadcast. The information received from the web would precede the action viewed on the time-shifted broadcast of the game.

In this example, the DVR being used to provide a time-shifted broadcast 211 broadcasts time perspective information 140 in the form of a timestamp. The timestamp indicates the viewer's perspective of time. Thus, if the game started at 6:00 PM and is being viewed at 10:00 PM using a DVR 110, the timestamp at the beginning of the game would be 6:00 PM.

The web application server 120 acquires the time perspective data 140 from the DVR 110. In an exemplary embodiment, the time perspective information further includes user or client identification for matching with a web page request. 150. The viewer uses a web browser 130 on a networked client device (in this case a personal computer) to request a sports site web page to view a shot tracker and play-by-play analysis. In the exemplary embodiment, the web page request 150 also comprises a user or client identification.

A web application server 120, which hosts the sports site, acquires the time perspective information 140 from the DVR 110 and receives the web page request 150 from the web browser 130. Using this information, the web application server 120 recognizes that the web page request 150 is associated with the time-shifted broadcast 211 and identifies a version of the requested web page that is time coordinated with the time-shifted broadcast. This may be accomplished, for example, by stepping back the version of the web page until it precedes the timestamp. The web application server 120 provides the time coordinated web content 160 (e.g., a prior version of the web page) to the networked client device 202 where it is displayed as a viewable time coordinated web content 212.

FIG. 4 is a block diagram of an alternative system for coordinating web content with a time-shifted broadcast according to an alternate exemplary embodiment of the invention. In this embodiment, a networked device such as a computer may acquire the timestamp and provide it to the web application server 420. A protocol such as UPnP may be used to establish communication between the DVR and the networked device. Alternatively, the DVR may be integral with the networked device. A browser 430 on the networked device makes a request for web content 450. In this exemplary embodiment, the browser appends program identification (such as a TV show) and a timestamp (user's perspective of time) to the User-Agent header of a web page request. Thus, the time perspective information 440 is included in the web content request 450.

A web application server 420 hosting the web site containing the requested web content acquires the time perspective information from the web content request 450. Using the time perspective information, the web application server identifies a version of the requested web content preceding the timestamp or time perspective of the time-shifted broadcast (time coordinated web content). This time coordinated web content 460, which is time shifted to correspond temporally to the time-shifted broadcast, is provided to the networked device. The networked device then provides the time coordinated web content 460 in a viewable form to a user interface, such as a monitor or the like.

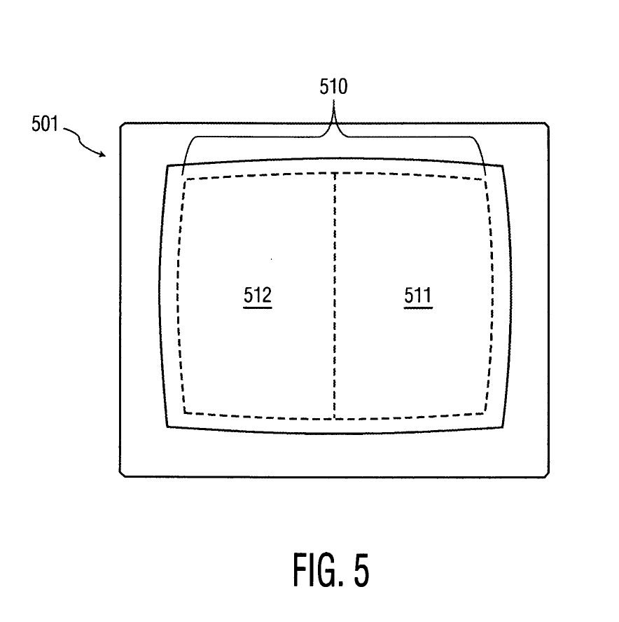

FIG. 5 is a display 501 presenting a time-shifted broadcast 511 and time coordinated web content 512 in a split screen according to an alternate exemplary embodiment of the invention. In this embodiment, a display 501, presents multiple feeds at the same time using a split screen or multiple windows. The display 501, may be, for example, a multimedia center having both an Internet and DVR feed or a monitor for a personal computer having an integral DVR. In an exemplary embodiment, the display 501 is presenting a time-shifted broadcast 511 on one part of the screen while simultaneously presenting web content 512 that is modified to coordinate with the time-shifted broadcast 511 on another part of the screen.

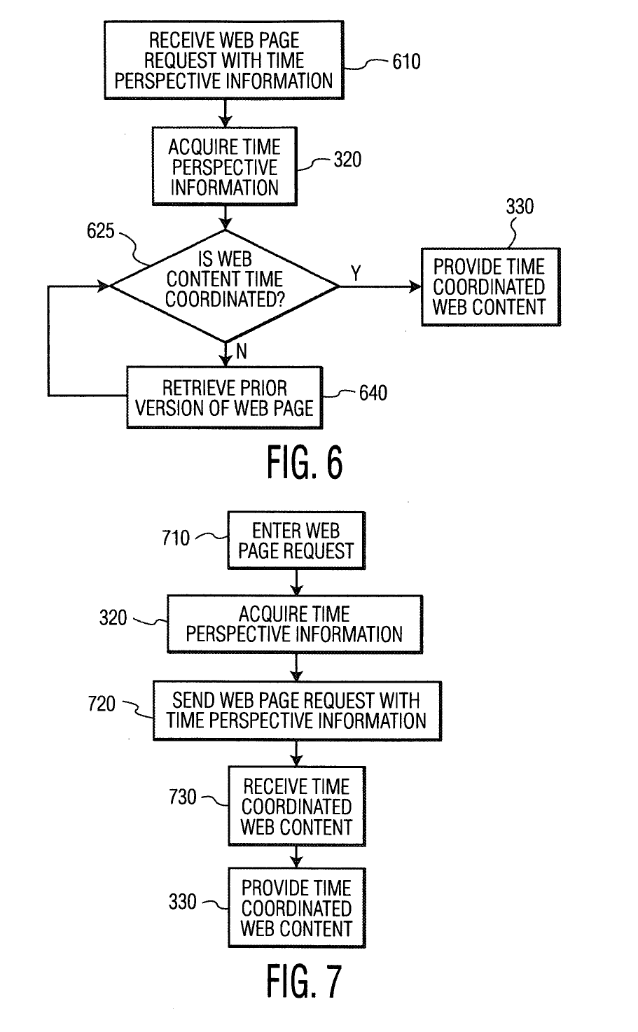

FIG. 6 is a flow diagram at a web site for another method for coordinating web content with a time-shifted broadcast according to an exemplary embodiment of the invention. A web page request having time perspective information is received from a web browser (step 610). The time perspective information may be, for example, program identification and a timestamp form a time-shifted web broadcast. This information may be incorporated into the web page request, for example, by appending the data to the http header.

The web site receiving the request, acquires the time perspective information (step 320). As previously discussed the web site is free to use or ignore the additional information appended to the header. Assuming the web site is set up to capture this information, the web site now has the time perspective of the user making the web page request. The web site can compare the time perspective of the user to its audit or versioning information (step 625). If the web page requested is time coordinated with the users perspective of time (i.e., the web page contains no information entered subsequent to the timestamp or user's perspective of time), then the web site provides the web page to the requesting user (step 330). If the web page requested is not time coordinated with the users perspective of time (i.e., the web page contains information entered subsequent to the timestamp or user's perspective of time), then the web site uses auditing or versioning information to retrieve a prior version of the requested web page (step 640). If the web page requested is now time coordinated with the user's perspective of time, then the web page is provided to the requesting user (step 330). Alternatively, content that is subsequent to the time perspective of the user could be deleted or hidden by the web site or the networked device.

FIG. 7 is a flow diagram at a networked client device for the method of FIG. 6 for coordinating web content with a time-shifted broadcast according to an exemplary embodiment of the invention. A user enters a web page request (step 710). The networked device acquires time perspective information for a time-shifted broadcast from the DVR presenting the time-shifted broadcast (step 320). The networked device sends a web page request with time perspective information to the appropriate web site (step 720). As described above, this may be achieved by appending the time perspective information to the http header.

As described with respect to FIG. 6, the web site identifies and returns time coordinated web content. The networked device receives the time coordinated web content from the web site (step 730). The networked device then provides the time coordinated web content to a display (step 330) where it is presented in viewable form.

Although illustrated and described above with reference to certain specific embodiments, the present invention is nevertheless not intended to be limited to the details shown. Rather, various modifications may be made in details within the scope and range of equivalents of the claims and without departing from the spirit of the invention.

What is claimed is:

1. A method for coordinating web media with a time-shifted broadcast, the method comprising the steps of:
acquiring time perspective information for a time-shifted broadcast; and
providing web content corresponding to the time perspective for the time-shifted broadcast.

2. The method of claim 1, wherein the time perspective information is a timestamp from a time-shifted broadcast.

3. The method of claim 1, wherein the time perspective information is a web client identification matching a DVR client identification periodically broadcast with a timestamp from a time-shifted broadcast.

4. The method of claim 1, wherein the time perspective information is a periodic broadcast of a client identification and a timestamp from a DVR running the time-shifted broadcast and wherein the web content that corresponds to the time perspective for the time-shifted broadcast is provided to a web client having a client identification matching the client identification from the periodic broadcast.

5. The method of claim 2, further comprising the steps of:
acquiring a client identification for the DVR running the time-shifted broadcast; and
acquiring client identification from a browser request for web content;
wherein web content is provided to the identified web client, the provided web content corresponding to the received timestamp.

6. The method of claim 1 further comprising the steps of:
requesting web content from a web server;
providing the time perspective information to the web server; and
receiving web content corresponding to the time-shifted broadcast from the web server.

7. The method of claim 6, wherein the time perspective information is a timestamp from the time-shifted broadcast.

8. The method of claim 6, wherein the time perspective information is a client identification matching a client identification periodically broadcast with a timestamp by a DVR running the time-shifted broadcast.

9. The method of claim 6, wherein the web content that corresponds to the time perspective for the time-shifted broadcast is provided at a user interface.

10. A method for coordinating web content with a time-shifted broadcast, the method comprising the steps of:
requesting web content;
providing information to establish a time perspective for the time-shifted broadcast; and
presenting web content corresponding to the time-shifted broadcast.

11. The method of claim 10 wherein the information is a timestamp of the time-shifted broadcast.

12. The method of claim 10 wherein the information is client identification from a DVR periodically broadcasting a timestamp of the time-shifted broadcast.

13. The method of claim 10 wherein the web content corresponding to the time-shifted broadcast comprises an archived web page prior to the time perspective for the time-shifted broadcast.

14. The method of claim 10 wherein the web content corresponding to the time-shifted broadcast comprises a web page with content created after the time perspective for the time-shifted broadcast hidden.

15. A program product comprising a machine usable medium having machine usable program code for coordinating web media with a time-shifted broadcast, said program product comprising:
machine usable program code for acquiring time perspective information for a time-shifted broadcast; and
machine usable program code for providing web content that corresponds to the time perspective for the time-shifted broadcast.

16. The program product of claim 15, wherein the time perspective information is a timestamp from a time-shifted broadcast.

17. The program product of claim 15, wherein the time perspective information is a client identification and a timestamp acquired from a periodic timestamp broadcast from a DVR running the time-shifted broadcast and wherein the web content that corresponds to the time perspective for the time-shifted broadcast is provided to a web client having an identification matching the identification from the periodic timestamp broadcast.

18. The program product of claim 16, further comprising:
machine usable program code for acquiring a client identification for the DVR running the time-shifted broadcast; and
machine usable program code for acquiring client identification from a browser request for web content;
wherein web content is provided to the web client with the identification acquired from the browser, the provided web content correspond to the received timestamp from the DVR with matching client identification.

19. The program product of claim 16 further comprising:
machine usable program code for requesting web content from a web server;
machine usable program code for providing the time perspective information to the web server;
machine usable program code for receiving web content corresponding to the time-shifted broadcast from the web server; and
machine usable program code for providing web content corresponding to the time-shifted broadcast.

20. A system for coordinating web media with a time-shifted broadcast, comprising a web site on a web application server configured to acquire time perspective information for a time-shifted broadcast and to provide web content corresponding to the time perspective for the time-shifted broadcast.
